(19) United States
(12) Patent Application Publication
(10) Pub. No.: US 2026/0303904 A1
(43) Pub. Date: Oct. 1, 2026

(54) AI Smart Handsfree Television

(71) Applicants: D'Anwar LeMon Hardeman, Richmond, TX (US); Ulerick Donnel Fields, Houston, TX (US); James Mathew Douglas, Houston, TX (US); Milton Earl Douglas, Houston, TX (US)

(72) Inventors: D'Anwar LeMon Hardeman, Richmond, TX (US); Ulerick Donnel Fields, Houston, TX (US); James Mathew Douglas, Houston, TX (US); Milton Earl Douglas, Houston, TX (US)

(21) Appl. No.: 19/578,873

(22) Filed: Mar. 26, 2026

Related U.S. Application Data
(60) Provisional application No. 63/781,843, filed on Apr. 1, 2025.

(51) Int. Cl. H04N 21/4415; G06F 3/01; G06F 3/16; G06F 21/32; G06V 40/70; H04N 21/258; H04N 21/422; H04N 21/4223; H04N 21/442; H04N 21/454

(52) U.S. Cl. CPC H04N 21/4415; G06F 3/017; G06F 3/167; G06F 21/32; G06V 40/70; H04N 21/25875; H04N 21/42203; H04N 21/4223; H04N 21/44218; H04N 21/454

(57) ABSTRACT

An artificial-intelligence-integrated smart television system featuring built-in biometric recognition, voice interaction, and AI-driven content generation. The system includes a microphone, camera, wireless connectivity, and an AI operating system configured to authenticate users through facial and voice recognition, personalize the user experience, and automatically enforce parental controls and screen-time limits based on detected user identity. Hands-free operation is enabled through voice commands and gesture controls, while integrated AI tools support content creation, avatar generation, and operation of an AI-simulated content channel. The system further provides multi-window display capabilities, real-time video interaction between users in different locations, social media integration, and compatibility with an application store for expanded functionality. Overall, the system delivers an advanced, intuitive, and highly interactive smart television platform that enhances entertainment, personalization, and user engagement through comprehensive AI integration.

The current application claims a priority to the U.S. Provisional Patent application Ser. No. 63/781,843 filed on Apr. 3, 2025.

### FIELD OF THE INVENTION

The present invention relates to the integration of artificial intelligence (AI) technology into television systems. More specifically, the present invention relates to an AI-enabled smart handsfree television.

### BACKGROUND OF THE INVENTION

With the rapid advancement of AI technology, there is a growing demand for integrating AI capabilities into everyday devices to enhance user experience and interaction. Traditional smart TVs offer limited functionalities and often require multiple devices to achieve a comprehensive smart home setup. The present invention addresses these limitations by providing an all-in-one smart TV with handsfree control options, offering a wide range of AI-driven features.

### SUMMARY OF THE INVENTION

The AI Smart Handsfree Television includes a built-in microphone and camera, enabling voice and facial recognition capabilities. The TV also features Wi-Fi connectivity, allowing it to interface with smart TVs and other HDMI-compatible devices.

### BRIEF DESCRIPTION OF THE DRAWINGS

FIG. 1 shows a TV of the present invention.

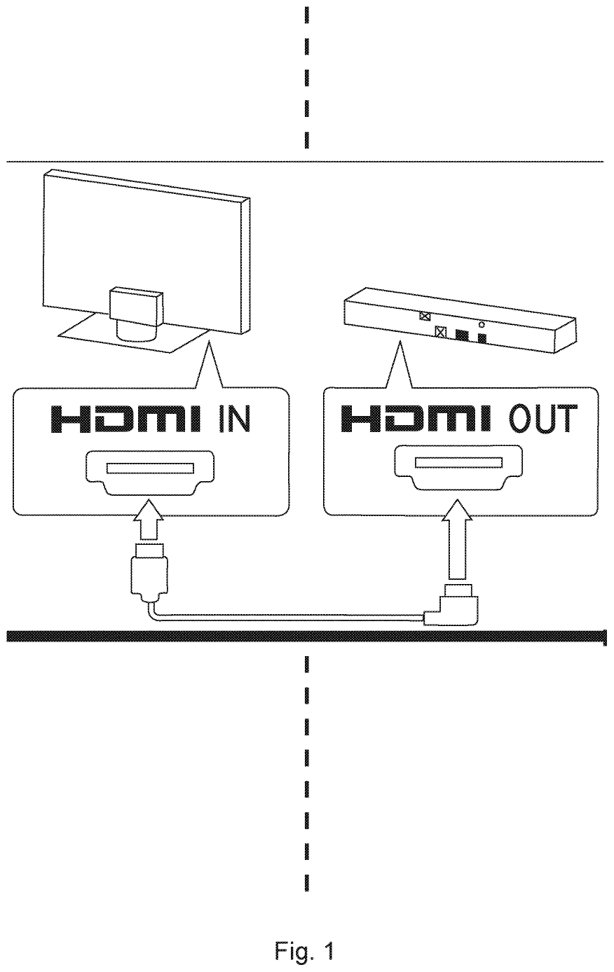

FIG. 2 shows an HDMI cable being inserted into the smart TV.

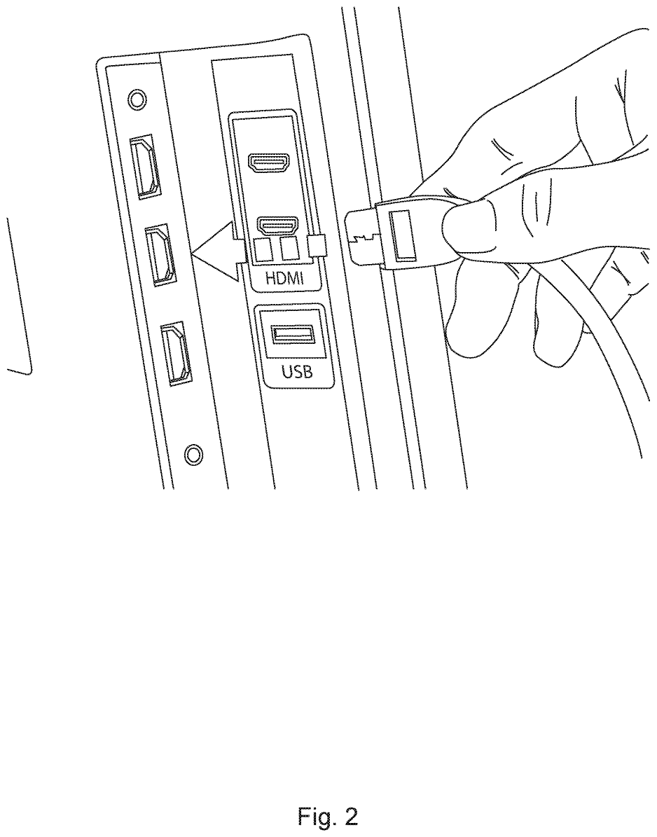

FIG. 3 shows the camera and microphone of the present invention.

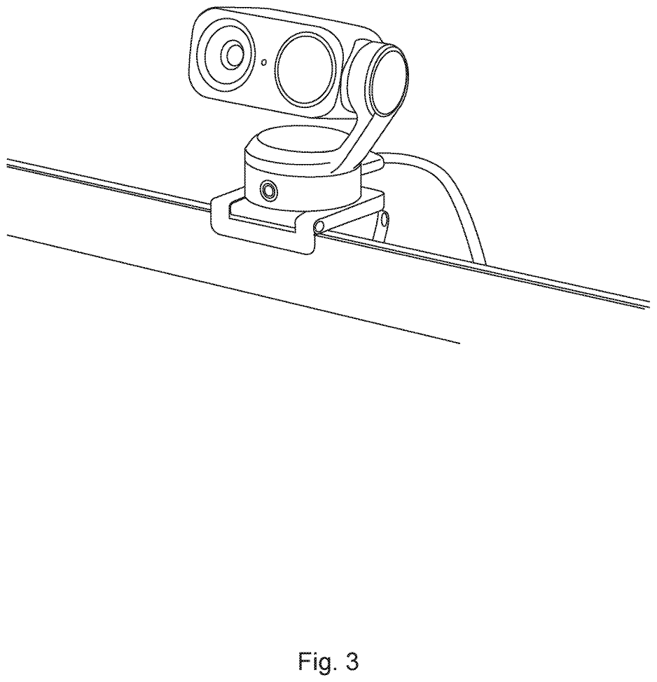

FIG. 4 is an example of a home screen where the user can select a personal profile.

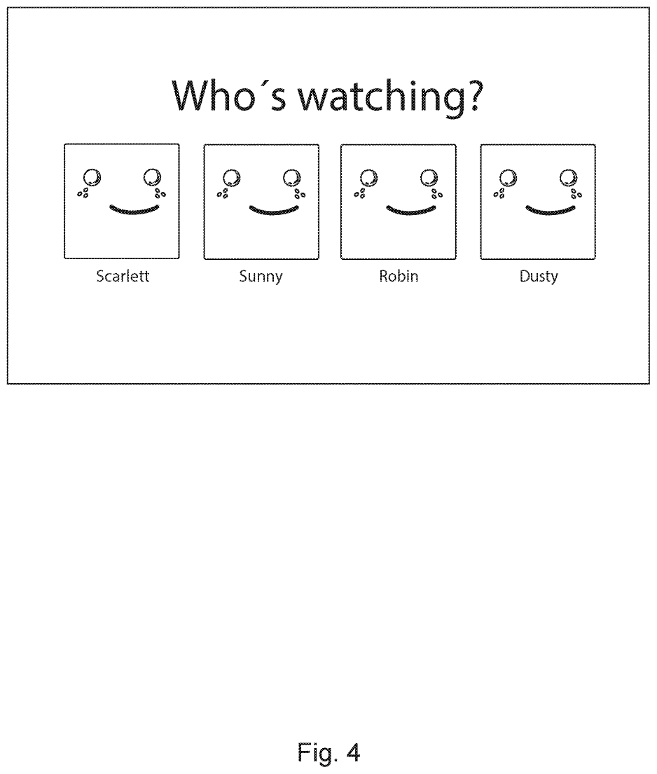

### DETAILED DESCRIPTION OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The present disclosure includes many aspects and features. Moreover, while many aspects and features relate to, and are described in the context of an AI Smart Handsfree Television, embodiments of the present disclosure are not limited to use only in this context.

The present invention relates to the integration of artificial intelligence (AI) technology into television systems, specifically through a Smart TV with built-in AI features. The present invention comprises a microphone and camera, enabling voice and facial recognition capabilities. With Wi-Fi connectivity, the present invention can access a variety of smart and AI-enhanced tools, apps, and features.

The present invention comprises a built-in microphone for capturing voice commands, and a camera for biometric facial recognition. The software configuration features a unique AI operating system that allows users to control smart TV functionalities through voice commands and other intuitive interactions. The camera and microphone work together to recognize users and log them in automatically, providing a personalized experience. The camera and microphone further enable automatic parental controls. A user may specify certain types of content with which they do not want their children to interact. If the camera recognizes a child in front of the TV, it may prevent the child from changing to a TV channel featuring a show or movie with a certain rating such as R or TV-14. It may prevent explicit songs from being played through a music app and may also prevent the child from playing certain video games. The present invention removes the need to set and turn off these parental controls manually. The present invention will automatically know whether the parental controls need to be active based on who is in front of the TV. The AI may further be used to control screen time. The user may allow a child a certain amount of screen time, and the TV will turn off automatically when the child has been in front of the screen for more than the approved amount of time. The camera and microphone allow the user to operate all TV functions featured on a standard remote control, such as play, pause, stop, rewind, menu navigation, etc., using voice controls. Users may also use motion controls. For example, a user may navigate different screens, windows, or menus by moving their hands.

The present invention has the ability to generate AI-driven content, including an AI channel that creates imaginary content through AI simulation. The integrated App Store allows users to download and install new apps, expanding the TV's capabilities. Users can control the TV and access various features using voice commands, stream content from basic channels, world news, creative content channels, and live TV streaming, and engage in interactive activities such as document viewing and reading (audio/avatar) and AI-generated content creation.

The present invention further includes biometric facial scanning for secure user authentication and allows users to create AI short films, movies, and other content using compatible apps from the App Store. Further, body and facial scanning may be used to create characters and avatars quickly and easily. Social media integration enables users to upload comments, likes, and dislikes to social media platforms for reviews on AI-generated content. The present invention provides an upgrade compared to existing smart TVs and HDMI devices with AI capabilities, providing a more interactive and user-friendly experience, and enabling the creation of AI broadcasting channels and television stations.

The present invention may work with any existing type of TV and will preferably feature 4k to 8k resolution. The present invention further comprises live TV to TV camera and video interaction, allowing users to watch movies, shows, or otherwise use the features of the TV in different locations in real time. For example, users in different locations may use video chat on the TV to watch a show together and talk to each other. The screen of the TV may comprise features and applications in multiple windows which can be closed, minimized, or faded. Users may have multiple windows open at once and can adjust them as needed to watch multiple windows at once, increase or decrease the size of a particular window, or filter out ones they are not watching.

Overall, the present invention offers enhanced user experience through handsfree, intuitive interaction with the TV, comprehensive functionality by combining multiple features into a single device, personalization through biometric scanning and user authentication, and expanded possibilities for home entertainment through AI content creation and sharing. This invention represents a significant advancement in the integration of AI technology into television systems, providing a comprehensive solution for enhancing smart TV functionalities and user interaction.

Although the invention has been explained in relation to its preferred embodiment, it is to be understood that many other possible modifications and variations can be made without departing from the spirit and scope of the invention.

What is claimed is:

1. A smart television system comprising:
a microphone configured to receive voice input;
a camera configured to capture biometric facial data;
a wireless communication module enabling access to remote networks;
an artificial intelligence operating system stored in memory and executed by a processor;
wherein the artificial intelligence operating system is configured to:
identify a user through facial recognition and automatically authenticate the user profile;
receive and interpret voice commands to control television functions;
automatically apply parental control restrictions based on detected user identity; and
generate or facilitate generation of AI-created media content;
thereby providing an interactive, personalized, and AI-enhanced television experience. The system of claim 1, wherein the parental control restrictions prevent access to television channels, movies, or programs exceeding a predetermined content rating.

2. The system of claim 1, wherein the parental control restrictions prevent playback of explicit audio content through music or streaming applications.

3. The system of claim 1, wherein the parental control restrictions prevent access to selected video games or applications.

4. The system of claim 1, wherein the parental control restrictions prevent access to selected video games or applications.

5. The system of claim 1, wherein the artificial intelligence operating system is further configured to monitor screen time of a recognized child and automatically disable the television upon exceeding an allotted usage duration.

6. The system of claim 1, wherein the microphone and camera operate jointly to authenticate users through multimodal biometric recognition.

7. The system of claim 1, wherein the system further comprises gesture-recognition software enabling control of menus, windows, or playback functions through user hand movements.

8. The system of claim 1, wherein the artificial intelligence operating system enables hands-free control of play, pause, stop, rewind, fast-forward, and menu navigation functions.

9. The system of claim 1, wherein the system includes an integrated application store enabling installation of third-party or proprietary applications.

10. The system of claim 1, wherein the artificial intelligence operating system is configured to generate AI-simulated content for display on a dedicated AI channel.

11. The system of claim 1, wherein the camera is further configured to capture body and facial data for generating avatars, characters, or digital models.

12. The system of claim 1, wherein the system enables creation of AI-generated short films, movies, or media content through installed applications.

13. The system of claim 1, wherein the system is configured to upload user reactions, comments, likes, or dislikes to social media platforms.

14. The system of claim 1, wherein the system supports real-time video communication between users in different locations while simultaneously displaying shared media content.

15. The system of claim 1, wherein the display supports multiple adjustable windows that may be opened, closed, minimized, resized, or faded.

16. The system of claim 1, wherein the artificial intelligence operating system provides personalized content recommendations based on recognized user identity.

17. The system of claim 1, wherein the system is configured to operate with televisions having resolutions between 4K and 8K.

18. The system of claim 1, wherein the artificial intelligence operating system enables interactive document viewing, reading, or audio narration.

19. The system of claim 1, wherein the system enables simultaneous streaming of basic channels, news channels, creative content channels, and live television.

20. The system of claim 1, wherein the artificial intelligence operating system is configured to manage multi-window interfaces allowing concurrent operation of applications, content streams, or AI-generated media.
